(19) United States
(12) Patent Application Publication
(10) Pub. No.: US 2024/0256242 A1
(43) Pub. Date: Aug. 1, 2024

(54) OPERATIONAL VALIDATION SYSTEM FOR SOFTWARE DEPLOYMENTS

(71) Applicant: State Farm Mutual Automobile Insurance Company, Bloomington, IL (US)

(72) Inventors: Luke Goyer, Chicago, IL (US); Jd Lafayette, Scottsdale, AZ (US); Nicholas Jorgensen, Mesa, AZ (US); James Todd, Flagstaff, AZ (US); Daniel Mercado, Tempe, AZ (US); Mallikarjun Merla, Phoenix, AZ (US)

(21) Appl. No.: 18/428,499

(22) Filed: Jan. 31, 2024

Related U.S. Application Data
(60) Provisional application No. 63/442,285, filed on Jan. 31, 2023.

(51) Int. Cl. G06F 8/60; G06F 8/73; G06F 11/36

(52) U.S. Cl. CPC G06F 8/60; G06F 8/73; G06F 11/3604

(57) ABSTRACT

Techniques described herein relate to determining and performing sets of validations associated with software deployment requests within continuous integration (CI) systems and/or other deployment environments. In response to a change event or other software deployment request, a validation system may automatically determine and execute a particular set of validation processes, and aggregate and analyze the results of the processes, prior to the integration of the requested code changes. In various examples, the validation system may determine customized sets of validations to perform for a requested software change based on factors such as the metadata of the software components to be changed, the computing environment into which the components are to be deployed, and/or the users initiating the requested code changes. The validation system also may automatically execute the validations by initiating any number of heterogeneous validation tools, receive and analyze the results of the validations to provide aggregated results and/or additional validation processes or remedial actions that can be executed prior to deploying to the requested software change.

### RELATED APPLICATIONS

This application claims priority to and is a non-provisional of U.S. Patent Application No. 63/442,285, filed Jan. 31, 2023, and entitled “OPERATIONAL VALIDATION SYSTEM FOR SOFTWARE DEPLOYMENTS,” the disclosure of which is incorporated by reference herein in its entirety for all purposes.

### TECHNICAL FIELD

The present disclosure relates to software development and deployment. In particular, the present disclosure describes techniques for determining and executing automated operational validations associated with requests for software component deployments within continuous integration (CI) systems and/or into other deployment environments.

### BACKGROUND

Continuous integration (CI) systems may refer to software development systems in which multiple developers and/or development teams working independently on an application may integrate their code into a shared source code repository. For instance, developers may implement new features or make changes to the codebase of the application, and then submit the code changes to the CI system to be integrated (or merged) within the shared source code repository. To make a change to the existing application codebase, a developer may check out a portion of the code from the shared repository into a local development environment, where the developer can alter and test their code without affecting other developers. After the updated code builds and executes satisfactorily in the local environment, the developer may check the code back into the shared repository. Developers may sync their local environments with the shared repository on a regular basis, so that changes submitted made by other developers are incorporated into their local environment.

To assure the continued operation and functionality of the application during development, the CI system may perform regular builds and functional testing on the shared source code repository. In some cases, CI systems are configured to automatically compile and build the application, and/or execute software test suites on the updated application based on a regular schedule (e.g., hourly, daily, weekly, etc.), or each time code changes from local environments are integrated into the overall codebase of the application. In some cases, CI systems may be associated with continuous deployment (CD) systems, in which the code changes integrated into the shared repository of the CI system are automatically tested and released into a production environment. When the CI system (or CI/CD system) detects a build failure or software functionality error caused by the integration of new code, the shared repository may be rolled back to the most recent version of the codebase that was successfully built and tested, and developers may work to analyze the failure by focusing on the code that was added or modified after the previous successful build. Rolling back code changes from the shared repository, as well as analyzing build and test failures, are technical and resource-intensive tasks that take time and have the potential to delay the product development cycle for the application. Accordingly, it is important for developers to thoroughly test any code changes within their local development environments, before those changes are checked into the shared repository of the CI system. It is also important for the CI system to perform frequent rebuilds and comprehensive functional test runs when the shared codebase of the application changes, so that any build breaks or software bugs can be quickly identified and resolved.

Before a developer (or development team) makes changes to a shared application codebase, the developer may perform a number of validations on the modified code and/or on the environment into which the code is to be deployed. In various development environments, any number of validation processes can be executed to validate different aspects of the application support and resiliency, compatibility, security, performance, and the like. In some examples, suites of software validation tools can be executed independently to perform validations on code changes, deployment environments, and/or additional systems associated with the CI system, the application, and/or the organization developing the application. For large-scale and robust applications developed by multiple development teams and/or organizations, the organizations may require large numbers of validations to be performed before integrating changes into the various software components within the application.

Although performing validations of software changes within CI systems and other development environments is valuable, it can also be inefficient and error-prone for some applications and/or in some environments. For instance, in some software development environments and organizations, individual users (e.g., developers, administrators, team leaders, etc.) may manually select, execute, and verify the results of various validation tools when performing software changes. However, manually executing and verifying validations can be inefficient, and can cause code integration delays when large numbers of validations are required. Further, individual developers and team leaders may decide to bypass certain validations, or may ignore certain warnings or errors in the validation results for code changes they consider to be minor or low-risk, or for validations they consider to be unnecessary or redundant.

Additionally, for large-scale applications that are developed and maintained by multiple developers (and/or multiple development teams), different developers/teams often perform different sets of validations when making code changes. In some instances, similar or identical changes to the software component may result in different sets of validations being performed, because the changes were made or submitted by different developers or teams. Further, when different users and/or development teams perform and verify different sets of validations independently, it may be technically difficult or impossible to track or analyze the validation results for the application as a whole. For instance, application administrators may be unaware of which validations were performed and not performed, and the associated validation results, when different development teams make different code changes. As a result, the administrators may be unable to enforce validation requirements or to track validation metrics over time for individual software components, development teams, and/or the application as a whole.

### SUMMARY

To address these and other problems and inefficiencies, this disclosure describes systems and techniques for determining and executing sets of operational validations associated with software deployments. Certain examples described herein relate to source code changes performed within continuous integration (CI) systems and/or continuous deployment (CI/CD) systems. Within such systems, users may submit requests (e.g., change events) to integrate source code updates into a shared codebase in the CI/CD system. Based on a request, a validation system may automatically determine and execute a particular set of validations prior to the integration of the requested code changes. As described below in more detail, the validation system may dynamically determine sets of validations to perform for a requested software change based on a number of factors, including (but not limited to) the metadata of the particular software components being changed, the computing environment into which the software components are being deployed, and the user(s) initiating the requested code changes, etc. After determining a particular set of validations to perform based on a requested software update, the validation system may automatically execute the validations by initiating a number of heterogeneous validation tools, each of which may be configured to perform separate validations on the software updates and/or the deployment environment. The validation system also may receive the results of the validations, aggregate the results (e.g., warnings, failures, validations not completed, etc.), and provide the results via a user interface to a deployment user (e.g., a development team leader, an application administrator, etc.).

Based on the validation results, the validation system may initiate the software integration into the shared codebase (e.g., automatically or via the validation user interface), may reject the software update request, and/or may initiate additional validation processes or remedial actions based on the validation results.

Although various examples described herein may refer to application source code changes within CI/CD systems, the techniques described herein may apply to various types of software component updates within any deployment environment. For instance, the validation systems described herein may be used to determine and maintain sets of validations, track validation results and metrics, etc., for making updates to application software (e.g., source code changes), executable software (e.g., applications and services) and/or any other software or computing resources within deployment environments. As used herein, a deployment environment for software may include a shared source code repository such as a CI/CD system, as well as cloud-based software test and/or production environments, including public clouds, private clouds, hybrid clouds, cloud containers (e.g., accounts), and/or on-premise computing infrastructures or any other computing environment into which software may be built and executed. In various examples, validation systems described herein for determining and executing sets of validations associated with software code changes and/or deployment requests may be implemented internally or externally to various additional systems/components in the computing environment. In some cases, the validation system may be implemented as a separate and independent computing system that is external to the code repository, the source code development environment, the CI/CD system, and the deployment environment. In such cases, the validation system described herein may provide further technical advantages in that it can be used across a range of technologies, including being used with any CI/CD system, any deployment environment, etc., as well as any number of different combinations of development environments, CI/CD systems, deployment environments, and/or validation tools.

As illustrated by the features and examples in this disclosure, the techniques described herein provide technical advantages that improve the functioning of CI/CD systems and/or other software deployment systems. These techniques implement a more secure, robust, and flexible system for performing validations in response to requested software changes, ensuring that the appropriate validations are performed for each requested software change, and confirming (e.g., prior to deployment) that both the requested software change and the configuration of the deployment environment have been sufficiently validated. The examples described herein also improve the speed and efficiency of CI/CD systems, by automatically executing the determined set of validations for a requested software change, and receiving and analyzing the results of the validations, prior to the review or approval of the requested change by a deployment user. Additional techniques described herein provide further advantages for large organizations and/or large-scale applications, via centralized management of the validation requirements and results tracking for different software components, development teams, and/or deployment environments.

In an example of the present disclosure, a computer-implemented method includes receiving, by a validation system, a software deployment request. In this example, the software deployment request may include an identifier associated with a software component and a deployment location. The method in this example may further include retrieving, by the validation system, metadata associated with the software component, based on the identifier, and determining a set of validations associated with the software deployment request, based at least in part on the metadata and the deployment location. The method also may include initiating one or more validation processes, based at least in part on the set of validations, and determining, by the validation system, a set of results of the one or more validation processes. Finally, the method may include initiating, by the validation system, deployment of the software component to the deployment location, based at least in part on the set of results.

In another example of the present disclosure, a computer system comprises one or more processors, and one or more non-transitory computer-readable media storing computer-executable instructions that, when executed by the one or more processors, cause the one or more processors to perform various operations. The operations in this example include receiving a software deployment request, the software deployment request including an identifier associated with a software component. The operations also may include determining a user associated with the software deployment request, and retrieving metadata associated with the software component, based on the identifier. Additionally, in this example, the operations include determining a set of validations associated with the software deployment request, based at least in part on the metadata associated with the software component. The operations may further include initiating one or more validation processes, based at least in part on the set of validations, and determining a set of validation results of the one or more validation processes. Finally, the operations in this example may include recording, in a validation results data store, an association between the set of validation results and the user.

Yet another example of the present disclosure includes one or more non-transitory computer-readable media storing instructions executable by a processor, wherein the instructions, when executed, cause the processor to perform various operations. The operations in this example include receiving a software deployment request including a software component identifier associated with a software component and a deployment location, and retrieving metadata associated with the software component, based on the software component identifier. In this example, the operations also include determining a set of validations associated with the software deployment request, based at least in part on the metadata, initiating one or more validation processes, based at least in part on the set of validations, and determining a set of results of the one or more validation processes. Finally, the operations may include initiating deployment of the software component to the deployment location, based at least in part on the set of results.

### BRIEF DESCRIPTION OF THE DRAWINGS

FIG. 1 depicts an example computing environment including an operational validation system configured to determine and execute validations based on software change events, and to initiate deployment of software changes into a CI/CD system based on the validations, in accordance with one or more examples of the present disclosure.

FIG. 2 illustrates the components of an example operational validation system, in accordance with one or more examples of the present disclosure.

FIG. 3 depicts an example user interface screen displaying the results of a set of validations associated with a software deployment request, in accordance with one or more examples of the present disclosure.

FIG. 4 depicts an example user interface screen displaying a set of validation metrics associated with a number of software deployment users and/or groups, in accordance with one or more examples of the present disclosure.

FIG. 5 illustrates an example process of determining and executing a set of validations associated with a software deployment request, and initiating deployment of a software component into an environment based on the validations, in accordance with one or more examples of the present disclosure.

FIG. 6 is an example architecture of a computer server capable of executing program components for implementing various techniques described herein.

### DETAILED DESCRIPTION

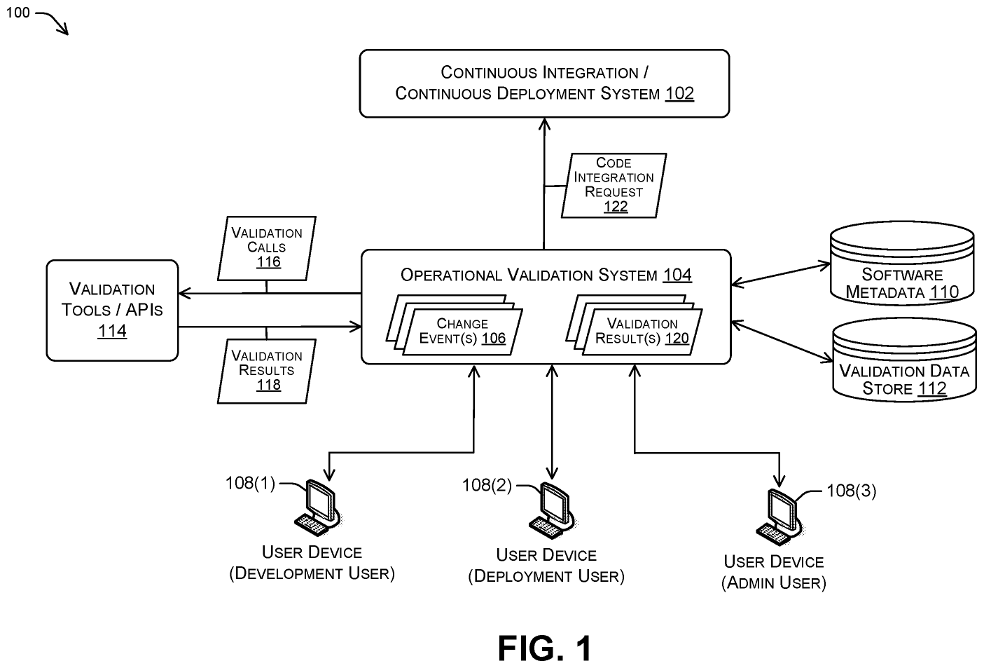

FIG. 1 shows an example of a computing environment 100 configured to validate requested software changes and initiate deployments of the requested software changes to a continuous integration and/or continuous deployment (CI/CD) system 102. As shown in this example, an operational validation system 104 (or validation system 104) may receive change events 106, representing requests for changes to software components (e.g., source code files) within the CI/CD system 102, via one or more user devices 108. Based on the received change events 106, the validation system 104 may determine and execute a set of validations on the particular software component(s) to be changed and/or the deployment environment into which the changes are to be made. After the determined set of validations is performed, the validation system 104 may receive and analyze the results of the validations, and may use the results to control the deployment of the requested software change into the CI/CD system 102.

As shown in this example, the validation system 104 may receive software deployment requests from user devices 108. A software deployment request (e.g., a change event 106) may correspond to a request to change the source code of an application maintained by the CI/CD system 102. In such examples, the change event 106 may identify one or more changes to a source code file, function, library, dependency, and/or other source code change to be deployed within an application codebase stored in the CI/CD system 102. Additionally or alternatively, change events 106 may identify updated executable files (e.g., services) to be deployed with a deployment environment (e.g., cloud-based environment) controlled by the CI/CD system 102. In these examples, the CI/CD system 102 may include one or more cloud service providers and/or cloud provisioning components configured to deploy and manage cloud-based deployments within public or private cloud environments, hybrid cloud environments, and/or on-premise deployment environments (e.g., datacenters).

To perform and analyze the validations for requested software changes, the validation system 104 may interact with various users having different roles and/or different authorization credentials via user devices 108. For example, the validation system 104 may receive software deployment requests (e.g., change events 106) from developers via user devices 108(1). In some cases, before the requested changes can be deployed to the CI/CD system 102, the changes may need to be reviewed and approved by deployment users (e.g., a senior developer or development lead) via additional user devices 108(2). Additionally, as described in more detail below, the validation system 104 may provide interfaces to interact with authorized administrators via user devices 108(3). Such interfaces may for example, allow authorized users to define the sets of validations required for particular software components, particular deployment environments, and/or particular developers/teams. The validation system 104 also may provide interfaces to allow authorized users to review and analyze the validation results/metrics for large numbers of change events performed over a time period, including groups of validations based on software components, developers or development teams, and/or deployment environments, etc. As described herein, user device(s) 108(1), user device(s) 108(2), and user device(s) 108(3) may be individually or collectively referred to as user device(s) 108. For the various types of roles and/or authorization levels described herein, the validation system 104 may provide separate functionality and/or may implement separate interfaces (e.g., user interfaces and/or APIs) to allow the various authorized users to perform the development, deployment, and/or administrative functionalities associated with the respective roles.

When the validation system 104 receives a software deployment request (e.g., change event 106) from a developer device or other user device 108, the request may include data identifying the software component to be changed (e.g., a source code file, class or function, executable or service, etc.), information describing the change (e.g., the updated source code or executable), and/or the deployment environment into which the requested change is to be deployed (e.g., a codebase within the CI/CD system 102 or other production environment). In some cases, the particular deployment environment may be implied by the change event 106, for instance, when either validation system 104 and/or the developer from which the request was received is associated with a single deployment CI/CD system 102 that maintains a single codebase. In other cases, the request may include data identifying a particular CI/CD system, codebase or repository, production or test environment, etc.

After receiving a software deployment request, the validation system 104 may use the information associated with the request to determine a set of validations to be performed prior to deploying the requested software changes. In some examples, the validation system 104 may retrieve the metadata associated with the change event 106 and/or the software components being changed from a metadata repository 110. Based on the metadata associated with the software components, the deployment environment, and/or other factors associated with the change event 106, the validation system 104 may retrieve a set of validations to perform based on the change event 106 from a validations data store 112. As noted above, a set of validations determined for a change event 106 may include validations performed on the software component itself, validations performed on the deployment environment, and/or validations performed on separate systems associated with the application, development team, and/or organization. Various types of validations, described in more detail below, may include functional testing validations, security validations, application support and/or resiliency validations, compatibility validations, performance validations, etc.

To perform a validation based on a requested software change, the validation system 104 may invoke one or more validation tools and/or APIs 114. The validation tools and/or APIs 114 may include any number of executable validation tools configured to perform validation tasks on the requested software changes, the deployment, and/or separate systems. In some examples, one or more executable validation tools may be stored on and run from the validation system 104 or an associated computing system. Additionally or alternatively, the validation system 104 may use APIs to invoke validation tools residing on separate external systems. For instance, validation system 104 may invoke APIs to execute validation tools that run on a user device 108(1) of a developer (e.g., to validate the source code prior to deployment) and/or validation tools on the CI/CD system 102 (e.g., to validate the conditions of the deployment environment).

As shown in this example, the validation system 104 may initiate validation calls 116 (e.g., API calls and/or direct execution of validation processes in the local environment) to execute/invoke the validation tools and/or APIs 114, based on the set of validations determined for the requested software deployment. In response to each validation call 116, the validation system 104 may receive one or more validation results 118, which may be analyzed, aggregated, and stored by the validation system 104 as validation results 120. As described below in more detail, the aggregated validation results 120 may indicate which validations have and have not been performed associated with a software deployment request, as well as the results of the validations that have been performed. Validation results 118 may vary based on the particular validation tool, and may include, for example, pass/fail indications, warnings or errors of various severity/criticality levels, and/or remedial actions to be taken to address any errors or issues found during a validation process.

In some examples, the validation system 104 may provide an interface (e.g., graphical UI and/or API) to allow deployment users (e.g., development leads, product heads, codebase administrators, etc.) to review the aggregated validation results 120 associated with a software deployment request. As described in more detail below, the validation system 104 may provide a user interface and/or notifications to one or more deployment users including the aggregated validation results 120, from which the users can review the results and perform additional actions. Such additional actions may include, for example, reviewing and/or storing individual validation results, comparing the validation results to the validation results associated with previous software changes, re-executing one or more of the validation processes, and/or executing different validation processes based on the results. Additionally, a user interface generated by the validation system 104 may allow the deployment user to approve the request and initiate the deployment of the software change into the CD/CI system 102 (or other deployment environment) based on the aggregated validation results 120.

Alternatively, the deployment user may reject the request via the user interface, based on the aggregated validation results 120, causing the validation system 104 not to deploy the requested software change and/or to notify the developer that the change event 106 has been rejected.

Further, although certain examples include user interfaces configured to allow deployment users to review the aggregated validation results 120, perform various validation actions, approve change events and initiate deployments, etc., in other examples the validation results 120 may automatically determine and initiate actions without receiving any response or feedback via a user interface. For example, the validation system 104 may use heuristics and one or more thresholds to determine when the aggregated validation results 120 associated with a change event 106 are sufficiently positive (e.g., above a validation completion and/or success threshold, or below a threshold number of warnings and/or errors, etc.) to permit the validation system 104 to automatically approve and initiate the requested software change. In other examples, the validation system 104 may approve and initiate a requested software change based on determining that the aggregated validation results 120 are similar or identical (e.g., within a similarity threshold) to a previous set of validation results performed for the same software component and/or the same deployment environment. Conversely, when the validation system 104 determines that the validation results 120 are negative for a change event 106, it may automatically reject the request and cancel the deployment of the requested software change. In some examples, the validation system 104 also may implement multiple ranges of intermediate thresholds for the validation results 120, which may cause the validation system 104 to automatically trigger one or more validation processes, notifications to developers or deployment users, and/or other combinations of validation-related actions, when the validation results 120 for a change event 106 fall within a particular threshold range.

In various implementations, the validation system 104 and/or any other combination of components within the computing environment 100 may be implemented within the CI/CD system 102, or may be implemented separately from the CI/CD system 102 (e.g., on separate servers, networks, separate clouds or datacenters, etc.). For instance, the CI/CD system 102 may be implemented within a central server managing the shared source code repository for an application, and the validation system 104 may operate as a component on the same central server. In such examples, the CI/CD system 102 may directly receive and respond to software change requests from developers to check out and/or check-in portions of the source code from the developer's local environment, and may invoke the validation system 104 in response to a change event 106 from a developer to perform the validation-related functionality described herein. In other examples, the validation system 104 may be implemented within the local development environment of one or more user devices 108(1), and/or may be implemented on a separate intermediary system. In these examples, a validation system 104 may be associated with one or more multiple CI/CD systems 102 or other backend deployment environments. In such cases, a software change request from a developer may be transmitted initially to the validation system 104, and then forwarded (e.g., when appropriate based on the validation results 120) to an appropriate CI/CD system 102 or other deployment environment.

As noted above, the CI/CD system 102 may maintain the codebase for one or more applications, for example, within shared source code repositories. The CI/CD system 102 may receive and manage requests from developers (e.g., directly or via the validation system 104), to check out portions of the application source code, which may be copied from the shared source code repository (or codebase) to a local development environment (e.g., on a developer user device 108(1)). After the checked-out source code is modified by the developer, the developer may submit a request (e.g., directly or via the validation system 104) to check-in (or integrate) the modified code back into the application codebase. As noted above, such requests may be referred to as software change requests and/or change events 106.

When a change event 106 has been approved via the validation system 104, the validation system 104 may approve and/or initiate the integration of the code change into the CI/CD system 102. As shown in this example, the validation system 104 may forward a code integration request 122 based on the change event 106, including the modified code from the developer's local development environment, to the CI/CD system 102. The CI/CD system 102 may receive and/or upload the modified code and perform the necessary code replacements or overwrites to merge the modified code from the developer into the application codebase within the shared repository. In some cases, the validation system 104 and/or the CI/CD system 102 may perform automated compiling, building, and/or testing as part of a code integration process, in order to verify that the incoming code changes do not break the build or introduce software bugs into the application. As noted above, CI/CD system 102 also may be configured to automatically rebuild and deploy the modified application into a production environment, in response to one or more changes made to the application codebase. However, in some cases the CI/CD system 102 may manage the integration of code changes into the shared repository but need not perform this continuous deployment functionality, and thus the CI/CD system 102 may be referred to as a CI system rather than a CI/CD system in some examples.

In various implementations, the validation system 104 may be associated with one or more other deployment environments, instead of or in addition to the CI/CD system 102. As noted above, the validation system 104 may be associated with multiple different CI/CD systems in some examples, where each CI/CD system manages one or more separate codebases. Additionally or alternatively, the validation system 104 may be associated with workload deployment and execution environments, including public, private, or hybrid cloud environments, cloud containers (e.g., accounts), and/or on-premise datacenters or other computing infrastructures. In such cases, the software change requests (e.g., change events 106) may include changes to executable files (e.g., executable applications or services) in the deployment environment.

When the deployment environment for a software change request includes a cloud-based environment, the validation system 104 may initiate the deployment using one or more cloud provisioning components and/or cloud service providers. For example, to perform a requested deployment of a software component into a deployment environment (e.g., a test or production environment), the validation system 104 may include (or may invoke) a cloud provisioning component configured to determine and execute cloud provisioning instructions that can be transmitted to an appropriate cloud service provider. In such examples, the validation system 104 may be associated with various different cloud service providers and/or cloud deployment types. In various examples, the validation system 104 may use provisioning instructions including executable code that can be executed directly by a cloud provisioning component. The validation system 104 and/or an associated cloud provisioning component may include infrastructure as code software instructions using a declarative configuration language in a structured format. To modify and/or generate the updated software components into the deployment environment, the cloud provisioning component may use languages including one or more of Terraform® by Hashicorp®, Cloudformation® by AWS®, Azure Resource Manager® by Microsoft Azure®, Cloud Deployment Manager® by Google®, Oracle Orchestration Cloud® by Oracle®, or Ansible® by Redhat®. It can be understood from this disclosure that these structured format languages are non-limiting examples only, and that any other domain-specific language for provisioning cloud deployments may be used in other examples.

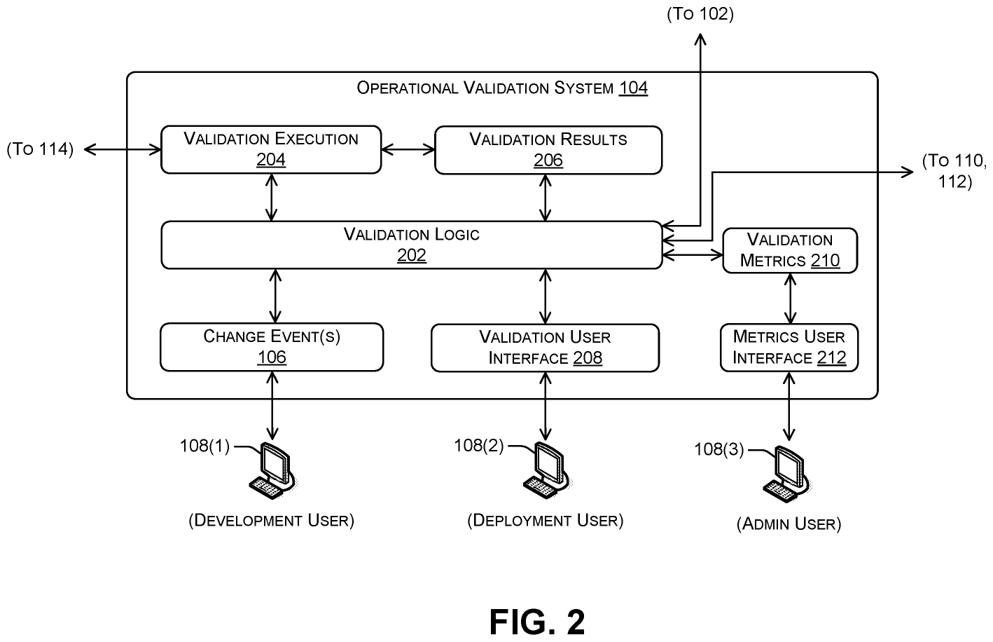

FIG. 2 depicts an example operational validation system (e.g., validation system 104) including a number of components configured to receive software deployment requests, and determine and execute a set of validations associated with the software deployment requests.

As described above, the validation system 104 may receive software deployment requests via user devices 108(1) from users such as software developers. A software deployment request (or software change request) may include a request to integrate source code updates to a shared codebase within the CI/CD system 102. Although software deployment requests are depicted as change events 106 in this example, in other instances the software deployment requests may include other requests to update source code within a source code repository and/or requests to deploy executable software components (e.g., cloud-based services) into a deployment environment such as public cloud, private cloud, on-premise computing infrastructure, etc.

In these various examples, a software deployment request may include information identifying the software component(s) to be added or changed, and information identifying the deployment environments where the changes are to be made. For change events 106, the information identifying the software component(s) may include names and/or paths of source files (e.g., including the particular functions and/or lines of source code to be changed), software classes or functions, libraries, etc., and the information identifying the deployment environment may include the network address of the CI/CD system 102, name or address or codebase or code repository, etc. In other examples, the information identifying the software component(s) may include a listing of cloud services or other executable components, and the information identifying the deployment environment may include one or more production environments or test environments within a cloud-based environment, etc. In various examples, software deployment requests (e.g., change events 106) may include additional information, such as the user(s) and/or development teams submitting the request, the time of the request, the version and/or build into which the software change is to be deployed, etc.

The validation logic 202 may be configured to determine a set of validations to be performed for a change event 106 (or other software deployment request) received from a developer. In some examples, the validation logic 202 may use the metadata repository 110 to determine one or more metadata attributes associated with the software component(s) identified in the change event 106. For instance, for a change event 106 that identifies a particular source code file to be modified in the CI/CD system 102, the validation logic 202 may look up the source code file in the metadata repository 110 to determine one or more metadata attributes associated with the source code file. Examples of metadata attributes that may be stored in the metadata repository 110 for particular source codes files can include, but are not limited to, a criticality level of a source code file, an indication of whether the source code file invokes other external components (e.g., classes, services, applications, etc.) and/or an indication of whether the source code file is part of a consumer-facing component (e.g., as opposed to an internal component that cannot be initiated by a consumer action). Although this example describes metadata attributes associated with source code files, in other examples the metadata repository 110 can store mappings between attributes and any type of software component and/or any level of granularity, including mappings between attributes and source code files, particular lines of code and/or code blocks, source code functions, classes, libraries, applications, services, and/or any other type of software component at any level of granularity.

In addition to retrieving mappings from the metadata repository 110 between software components and metadata attributes, the validation logic 202 may use other techniques to determine additional metadata and/or attributes associated with a change event 106 (or other software deployment request). For example, the validation logic 202 may analyze the change event 106 to determine an extent (or degree) attribute for the requested software change. For instance, the extent of a software change can be measured based on the number of lines of code changed, the number of source code files changed, the number of different functions/classes changed, etc.

The validation logic 202 also may use the identity of the user (e.g., developer) requesting the change as a metadata attribute of the change event 106, as well as the group/software development team initiating the change, the project or application being changed, etc., as a metadata attribute of the change event 106, as well as the group/software development team initiating the change, the project or application being changed, etc. Other metadata attributes determined by the validation logic 202 for a software change request may include time-based attributes, such as the time of day of the request, the day/date of the request, the time of the request relative to a code check-in deadline or component deployment deadline, etc. The validation logic 202 also may determine location-based attributes for a software change request, including the geographic location and/or computing network from which the change event 106 was requested by the developer, or the geographic location of the computing environment (e.g., CI/CD system 102, cloud-based environment, datacenter, etc.) into which the software change is to be deployed.

After determining the metadata attributes associated with a requested software change (e.g., a change event 106), the validation logic 202 may use the metadata attributes to determine a set of validations to be performed for the requested software change. For instance, the validation data store 112 may include mappings between particular attributes of the software components to be changed, and associated validations to be performed prior to (or otherwise in connection with) the requested change. As examples, based on the mappings in the validation data store 112, the validation logic 202 may determine different sets of validations to be performed for changes to software components having different criticality levels and/or different consumer-facing or non-consumer-facing attributes, etc. In other examples, based on the mappings in the validation data store 112, the validation logic 202 may determine different sets of validations for changes to software component(s) that invoke a particular library, service, or network, etc. In additional examples, based on the mappings in the validation data store 112, the validation logic 202 may determine different sets of validations for large-scale change (e.g., above one or more threshold of code lines changed, functions affected, etc.) versus medium or small-scale changes, etc.

Additionally or alternatively, the validation data store 112 may store mappings between attributes of the requested deployment environment and/or various other metadata attributes associated with the software change request, and associated sets of validations to be performed. For example, based on mappings in the validation data store 112, the validation logic 202 may determine different sets of validations to perform for software changes requested by different users and/or from systems (e.g., particular developers, development teams, networks, geographic regions, etc.). As another example, the validation data store 112 may store mappings between different deployment environments and/or deployment platforms and sets of validations to be performed. For instance, when the deployment environment is a particular shared codebase within the CI/CD system 102, the validation logic 202 may determine one set of validations, and may determine a different set of validations when the environment is a different codebase within the same CI/CD system 102, and/or different CI/CD system, etc. In other examples, based on the mappings in the validation data store 112, the validation logic 202 may perform different sets of validations for deployment environments in different public clouds, or different public/private/hybrid cloud environments, etc. Additionally, based on the mappings in validation data store 112, the validation logic 202 may perform different sets of validations for software changes to be deployed in AWS® cloud platforms, Microsoft Azure® cloud platforms, Google Cloud® cloud platforms, etc. In still other examples, the validation logic 202 may use the mappings in the validation data store 112 to determine different sets of validations to perform for changes to be deployed in test environments versus production environments, and/or between different production environments, etc. Additionally, the validation logic 202 may use the mappings in the validation data store 112 to determine the set of validations to perform based on the geographic region(s) of the deployment environment (e.g., using different sets of validation requirements for different regions, networks, and/or legal jurisdictions, etc.).

As described in the above examples, the validation logic 202 may use any attribute, and/or combinations of multiple attributes, associated with a requested software change to determine the set of validations to perform in connection with the software change. For instance, the validation logic 202 may determine a combination of validations to perform for a requested change event 106 by aggregating a first set of validations associated with the software component(s) being added/modified, a second set of validations associated with the deployment environment, a third set of validations associated with the developer submitting the change event 106, etc. In various examples, the validation logic 202 may include heuristics and/or machine-learned models to determine customized sets of validations to be performed based on any combination of the attributes associated with software change requests described herein.

Based on the set of validations determined by the validation logic 202 for the requested software deployment, the validation system 104 may use the validation execution component 204 to initiate one or more validation processes to perform the validations. As noted above, validation processes may be executed on the validation system 104, or may be invoked on other systems (e.g., a developer user device 108(1), the CI/CD system 102, a third-party system, etc.) via APIs. As described herein, a validation process can include any computing process configured to perform validation functionality for a requested software change, including (but not limited to) validation of new or modified software components (e.g., source code and/or executable software), and/or validation of the deployment environment for the requested software change. As described below, additional validation processes may operate on and/or validate conditions on separate systems to confirm application support, documentation, etc.

In various examples, the validations performed or invoked by the validation execution component 204 may include any type of validation process related to application support and resiliency, compatibility, security, performance, and the like. As an example, a validation process related to application support may verify that an on-call list has been established to support the application in the deployment environment, including verifying a sufficient number of on-call members having valid contact numbers to support the application. As another example, a validation process for application support may verify that source code change records and documentation (e.g., an explanation of the changes, the functional test results, etc.) has been uploaded to a code documentation repository. Another example of a validation process for application support may verify the presence of particular monitoring tools within the deployment environment that are configured to detect application failures and perform an appropriate responsive action (e.g., transmit notifications to a developer or team leader, initiate a failover process to a backup server, etc.).

Additional validations initiated by the validation execution component 204 can include security-related validations, performance-related validations, compatibility validations, etc. By way of example, the validations determined and executed for a requested software change may include a security-related dependency scanning tool configured to detect publicly disclosed vulnerabilities contained with the dependencies of a software component, endpoint security validation, data exfiltration validation, lateral movement vulnerability validation, etc. Additional examples of performance-related validations that may be initiated by the execution component 204 for particular software change requests may include initiating performance testing tools on builds including the modified code to perform one or more of stress testing, spike testing, load testing, endurance testing, and/or scalability testing for the requested software change.

After initiating the determined validations for a software change event 106 via the execution component 204 (e.g., by invoking one or more of the validation tools and/or APIs 114), the validation system 104 may receive and store the results of the validations. In some examples, a validation results component 206 may receive and aggregate the validation results from any number of validation tools associated with a change event 106, and store the aggregated set of validation results in the validation system 104. As noted above, the validation results component 206 also may analyze the aggregated validation results (e.g., based on one or more validation completion or success thresholds, and/or based on previous validation results). Further, based on the analysis of the validation results for a change event 106, the validation logic 202 may determine and initiate various additional actions based on the validation results (e.g., notifications, validation re-runs, remedial actions, etc.).

Thus, as discussed above, the validation system 104 may improve the speed and efficiency of the CI/CD system 102 and/or the software development techniques and procedures used by the organization for developing, validating, and deploying software changes. As noted above, some software development environments and/or systems may require a deployment user to review and approve change events 106 along with the set of validation results associated with the change events 106, before the corresponding software changes can be integrated into the CI/CD system 102 (or other deployment environment). In some instances, the validation system 104 described herein may automatically determine customized sets of validations for requested software changes, perform the validations, and aggregate/analyze the validation results directly in response to the submission of a change event 106 by a developer, and before the deployment user is notified of the change event 106. Thus, these techniques may improve the consistency of the validations performed, as well as reducing or eliminating the time required by deployment users to perform validations and review the validation results associated with the change events 106. As a result, these techniques improve both the quality of software component integrations into shared deployment environments, and allow for quicker deployments by reducing the time between the submission of change events by developers and the successful validation and deployment of the software changes.

After receiving and aggregating a set of validation results associated with a change event 106 (or other software deployment request), the validation logic 202 also may analyze the validation results to determine one or more subsequent actions to perform associated with the change event 106. In some examples, in response to receiving a request from an authorized deployment user device 108(2), the validation system 104 may provide a validation user interface 208 to allow the deployment user (e.g., a senior developer or development lead) with the aggregated validation results. In some examples, different deployment users may be associated with and authorized to review/approve different change events 106. In such examples, the validation system 104 may be configured to transmit notifications to particular deployment users in response to receiving completed validation results for a change event 106 associated with the particular deployment user. The validation system 104 also may authenticate login requests from deployment users so that, in response to a successful login attempt, the validation user interface 208 associated with the deployment user can be populated with the validation results for any or all of the user's change events 106.

Via a validation user interface 208, the validation system 104 may provide the deployment user a view of the aggregated validation results and/or an overall validation score for a change event 106. The validation user interface 208 also may include aggregations of validation issues (e.g., warnings, errors, incomplete validations or validations that were not executed or were not run, etc.) encountered across the various different validations processed. In some examples, the validation user interface 208 also may provide a view comparing the aggregated validation results to previous sets of validation results associated with previous change events 106 (e.g., change events to the same software components and/or by the same developer or team). By providing the aggregated validation results for a change event 106 in a single view or user interface screen, based on results compiled from any number of different validation tools or processes, the validation user interface 208 allows the deployment user to more quickly and comprehensively review the complete set of validation results for a change event 106 (or group of associated change events 106), rather than requiring the deployment user to review the outputs separately from the various different validation tools and/or APIs 114.

In some examples, the validation logic 202 also may determine one or more potential actions that can be performed based on the aggregated validation results for a change event 106. The potential actions may include, for example, re-executing validation processes, executing different validation processes, executing remedial processes to correct validation errors or warnings, or notifying associated users/entities. Any or all of the possible actions determined for change event 106 based on the aggregated validation results may be included in the validation user interface 208, to allow the deployment user to review and/or initiate one or more of the possible actions.

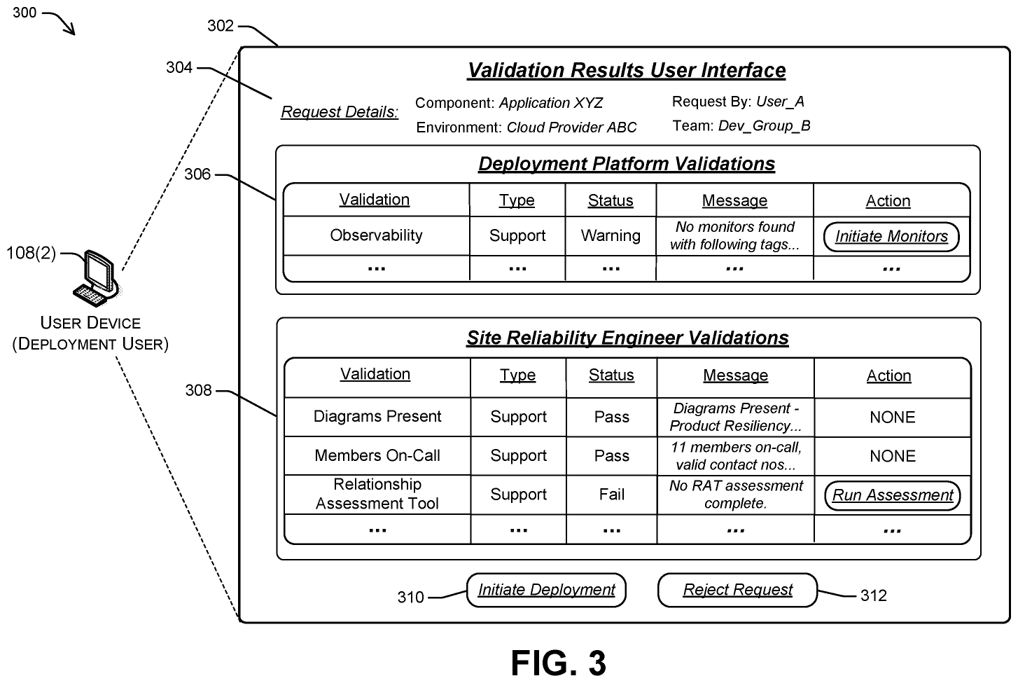

For example, FIG. 3 depicts an example user interface screen 300 displaying the results of a set of validations performed by the validation system 104 associated with a change event 106 (or other software deployment request). In this example, the user interface screen 300 may be generated by the validation user interface 208 of the validation system 104, for an authorized deployment user associated with the change event 106. As shown in this example, the user interface screen 300 includes a validation results user interface window 302 displaying a set of request details 304, a first listing of deployment platform validations 306, and a second listing of site reliability engineering validations 308. In this example, the request details 304 may include a set of details related to the change event 106, including the software component(s) to be changed via the change event 106, the environment into which the changes are to be deployed, the user (e.g. developer) that submitted the change event 106, and the development team associated with the user.

Although only two listings of validations results are shown in this example, in other examples any number of different validation results listings may be displayed and may be organized in various different ways. Both for the listing of deployment platform validations 306 and the list of reliability engineering validations 308, these listings show the validations that have been performed for the change event 106, the validation type, results/status, messages associated with the validation results, and links to initiate various actions (if applicable) that may be performed based on the validation results. Finally, in this example, after reviewing the validation results and/or performing one or more of the available actions, the user may select a first control button 310 to approve the validation results and initiate the deployment of the software change to the deployment environment, or a second control button 312 to reject the change event 106 and pause or cancel the deployment of the software change.

Returning to FIG. 2, although a validation user interface 208 is shown in this example, in other examples the validation logic 202 may analyze the validation results component 206 and may automatically perform any of the possible or recommended actions associated with a change event 106 as described herein. In such cases, a validation user interface 208 may be optional, and based on heuristics and/or machine-learned models executed by the validation logic 202, the validation system 104 may automatically perform various actions within any explicit approval or action from a developer or deployment user via a user interface. As an example, based on receiving certain validation warnings or errors, or failures to complete one or more validations, the validation logic 202 may automatically initiate additional validation or remedial actions to address the previous validation failures. In some instances, a set of validations completed with a sufficiently high overall score (e.g., below a threshold number of warnings or errors, above a threshold success rate, etc.) may cause the validation logic 202 to automatically approve the change event 106 without explicit approval from the deployment user via the user interface. Similarly, for an incomplete set of validations and/or results below a threshold score (e.g., above a threshold number of warnings or errors, etc.), the validation logic 202 may automatically reject the change event 106 and/or notify the user (e.g., developer) that submitted the request, without explicit action from the deployment user.

In some examples, the validation system 104 also may include components to track and monitor the validation metrics received for validations performed for any number of change events 106. As shown in this example, the validation system 104 may include a validation metrics component 210 configured to store validation metrics over a period of time, including organizing set of validation results by, for instance, user, time, software component, validation type, and the like.

In some examples, the validation system 104 also may include components to track and monitor the validation metrics received for validations performed for any number of change events 106. As shown in this example, the validation system 104 may include a validation metrics component 210 configured to store the sets of validations performed associated with various change events 106, and the results of the validations over a time period. The validation metrics component 210 also may store associations between sets of validation results, including organizing and/or grouping the sets of validations executed and validation results based on the software components changed via the change events 106 (or other software deployment requests), the deployment environments for the software components, the users requesting the software changes, and/or any other attributes associated with the change events 106. Additionally or alternatively, the validation metrics component 210 also may organize and/or group validation executions and results based on the particular validation processes and/or types of validations (e.g., support-related validations, security-related validations, performance-related validations, etc.).

As shown in this example, the validation system 104 also may provide a validation metrics user interface 212 in response to receiving requests from authorized administrator user devices 108(3), to allow administrators to view and analyze historical validation data. The historical validation data may include the listings of which particular validations were executed in connection with each change event 106, as well as the validation results. Using the validation metrics user interface 212, the administrator can view, group and aggregate metrics, and/or generate reports based on any combination of the criteria described herein (e.g., by software component, by application, by time range, by deployment environment, by developer, by development lead, by validation or validation type, etc.).

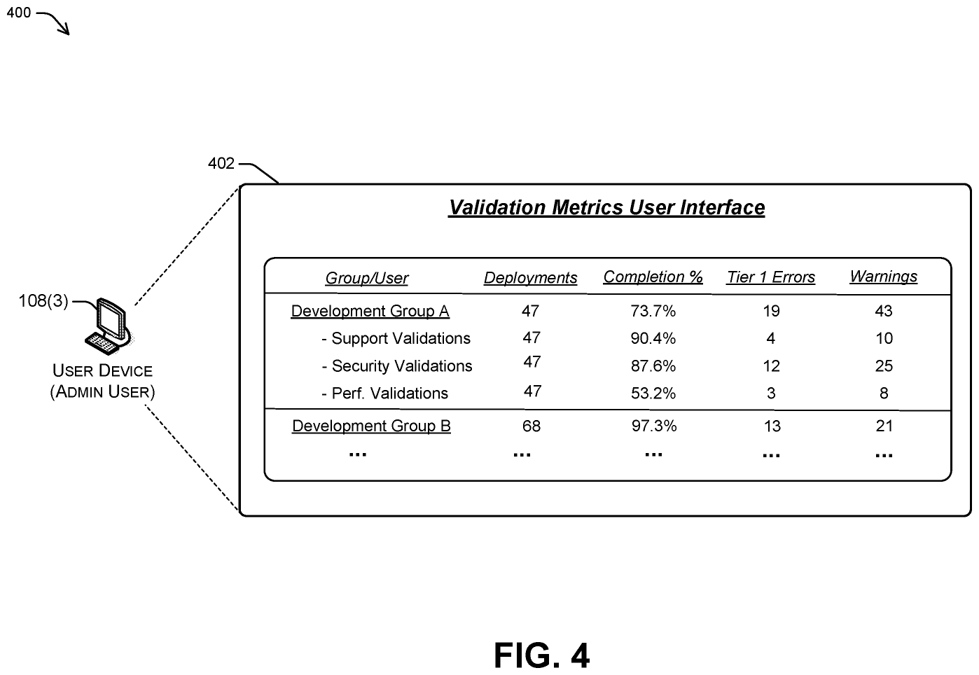

For example, FIG. 4 depicts an example user interface screen 400 displaying a set of validations metrics performed by the validation system 104 in response to a number of change events 106 over a time period. In this example, the user interface screen 400 includes a metrics window 402 displaying the validation metrics associated with a particular development group (e.g., Development Group A). In this example, the metrics window 402 displays the total number of deployments (e.g., change events and/or code check-ins associated with the development group, and the validation results grouped by validation type (e.g., Support Validations, Security Validations, Performance Validations, etc.). The validation results in this example include the completion percentage (e.g., of the validations required for the particular software change request) and the aggregated number of Tier 1 Errors and Warnings within the validations performed by Development Group A during the time period. Although not shown in this example, the validation metrics user interface 212 may similarly be organized by user (e.g., the developer submitting the change event 106), or by software component (e.g., source code file, class, service, application, etc.), and/or by individual validations (e.g., rather than grouping by validation types).

Additionally, although not shown in FIG. 3, the validation metrics user interface 212 also may include components to allow administrator users to change any of the heuristics (e.g., rules) used by the validation logic 202 to determine/perform sets of validations based on change events 106, and/or to change any of the mappings in the metadata repository 110 or validation data store 112. For example, via the validation metrics user interface 212, an administrator may change the metadata attributes of the software components in the metadata repository 110 (e.g., changing criticality levels, etc.). The administrator also may use the validation metrics user interface 212 to change which validations are associated with which metadata attributes, which deployment environments, and/or developers/development teams, etc.

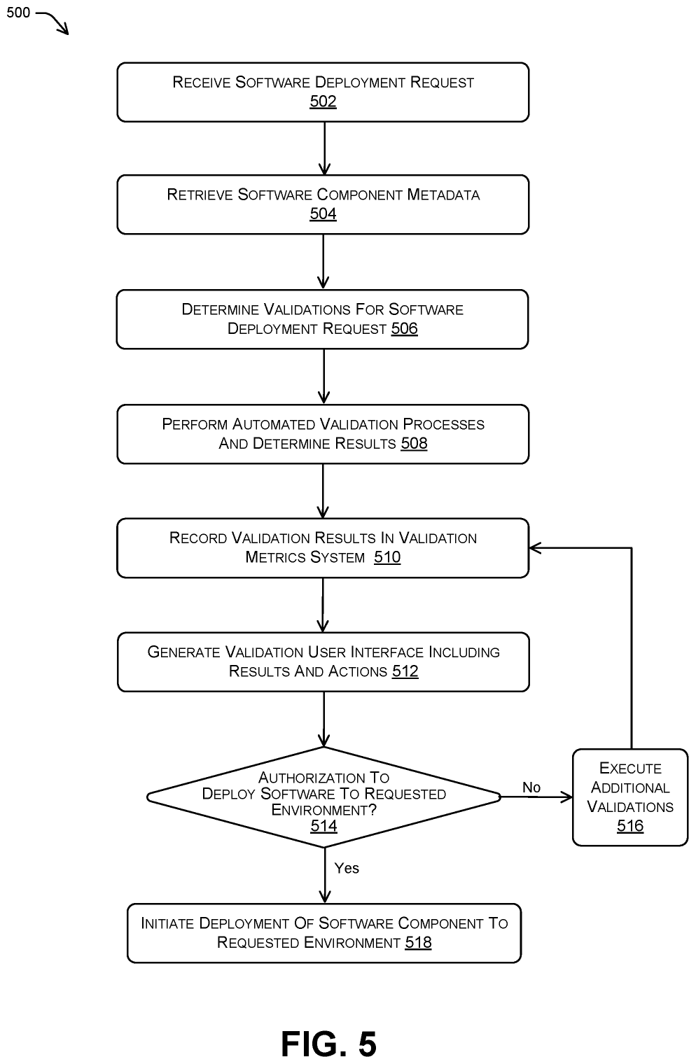

FIG. 5 is a flow diagram illustrating a process 500 of determining and executing a set of validations associated with a software deployment request, and, based on the validations, initiating the deployment of the software component into the deployment environment. As described below, the operations of process 500 may be performed by a validation system 104, including some or all of the related components discussed above in connection with FIGS. 1-2. In some implementations, the validation system 104 may be implemented within or otherwise associated with a CI/CD system 102, and the software deployment request may correspond to a change event 106 submitted by a developer to integrate a source code change into a shared codebase of the CI/CD system 102. In other examples, the validation system 104 may be implemented separately and independently of the CI/CD system 102, and/or may be used as an intermediary system between any number of developer devices and any number of CI/CD systems. Additionally or alternatively, the software deployment requests described in process 500 may include requests to deploy cloud-based resources (e.g., services or other compiled and built executables) into a cloud-based deployment environment or datacenter computing infrastructure.

At operation 502, the validation system 104 may receive a software deployment request from a user device 108(1). As described above, the software deployment request may correspond to a request from a developer to integrate updated source code from a local development environment into a shared codebase within the CI/CD system 102. In other examples, the software deployment request may correspond to a request to deploy an updated executable (e.g., cloud service) into a deployment environment (e.g., a test or production cloud-based environment). The request in operation 502 may include data identifying the software components to be changed (e.g., source code files, functions, applications, services, etc.) and the deployment environment into which the software components are to be integrated.

At operation 504, the validation system 104 may retrieve metadata associated with the software components in the request. In some examples, the validation system 104 may access the metadata repository 110 and retrieve the metadata attributes associated with the software component(s) to be changed. Examples of metadata attributes may include, for instance, a criticality level associated with the software component, an indication of whether the component invokes other external components, an indication of whether the component is part of a consumer-facing application, etc.

At operation 506, the validation system 104 may determine a set of validations to be performed in connection with the software deployment request. In some examples, the validation system 104 may access the validation data store 112 to retrieve one or more sets of validations associated with the software deployment request. For instance, the validation system 104 may determine individual validation sets associated with each metadata attribute of the software component(s). Additionally or alternatively, the validation system 104 may determine validation sets associated with the deployment environment (and/or type of deployment platform) into which the software change is requested, the user (e.g., developer or development team) submitting the software deployment request, and/or any other metadata attributes associated with the request.

At operation 508, the validation system 104 may initiate one or more automated validation processes to perform the set of validations determined in operation 506. As described above, the validation system 104 may use a validation execution component 204 to initiate any number of validation processes (e.g., in parallel) to perform the determined set of validations. Some validation processes may be local tools executed on the validation system 104, while others may be invoked remotely on other systems via APIs, including validations performed on the developer's local environment (e.g., on user device 108(1)), validations performed on the deployment environment (e.g., CI/CD system 102), or validations performed on separate computing devices.

At operation 510, the validation system 104 may receive and store the results from the validation processes performed in operation 508. Additionally, as shown in this example, the validation system 104 may record the listing of validations performed in connection with the software deployment request, along with the validation results, in a validation metrics system (e.g., validation metrics component 210).

At operation 512, the validation system 104 may generate and provide a validation user interface displaying the validation results and/or potential actions that may be performed based on the validation results. The user interface provided in operation 512 may correspond to the validation user interface 208. In some examples, the user interface may be provided in response to an authenticated request from a deployment user (e.g., senior developer, development team lead, etc.), to allow the deployment user to review the software change request and validation results, and then approve or reject the request. As described above, the user interface may include links to allow the user to initiate a number of potential actions based on the validation results. For instance, the potential actions may include executing or re-executing one or more validation processes, or executing remedial tools based on failures or errors in the validation results. Additionally or alternatively, and/or potential actions selectable via the user interface may include approving the request (e.g., to initiate the deployment of the software change) or rejecting the request (e.g., to cancel the deployment and notify the developer, etc.).

At operation 514, the validation system 104 may determine whether the deployment user has approved, via the user interface, the requested deployment of the software. In some cases, the user may review the validation results and immediately approve the software change request (e.g., change event 106) via the user interface. In other cases, the user may review the validation results and then perform one or more additional validation-related actions before approving the request. When the user does not immediately approve the request and instead selects additional actions to be performed (e.g., additional validations, remedial validation tools, etc.) (514: No), then at operation 516 to the validation system 104 may perform the additional actions/validation tools. After performing the additional actions/validation tools, the validation system 104 may update the validation metrics at operation 510 and update the user interface to reflect the updated validation results at operation 512.

When the deployment user does approve the software deployment request via the user interface after reviewing the validation results (514: Yes), then at operation 518 the validation system may initiate deployment of the software component to the requested deployment environment. As described above, in some examples deploying the software to the deployment environment may correspond to integrating the code change into the CI/CD system 102 (e.g., via a code integration request 122). In other examples, deploying the software to the deployment environment may correspond to provisioning and deploying the executable component (e.g., cloud service) to the cloud environment (e.g., via a cloud provisioning component and cloud service provider).

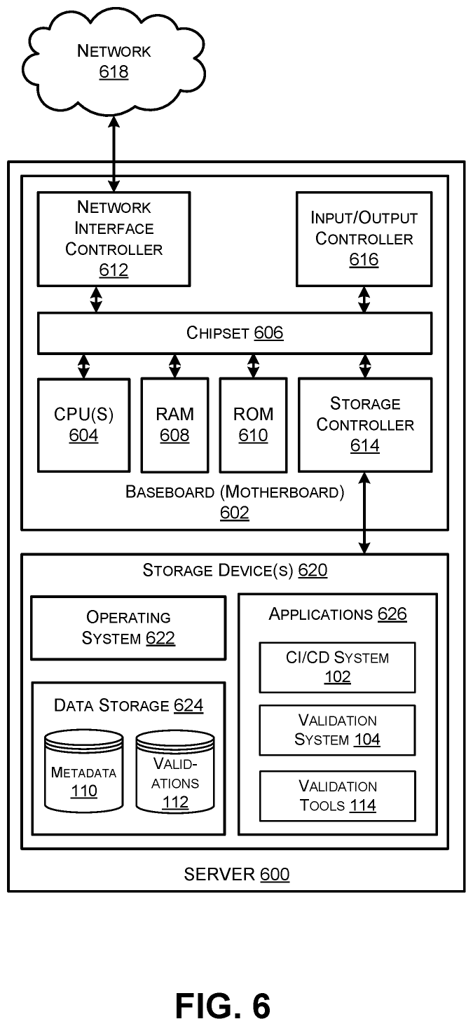

FIG. 6 shows an example architecture of a server 600 capable of executing program components for implementing the various functionality described herein. Although the computer architecture in this example is labeled as a server, it can be understood from this disclosure that similar or identical computer architectures may be implemented via workstations, desktop or laptop computers, tablet computers, network appliances, mobile devices (e.g., smartphones, etc.) or other computing device, and/or virtual machines or cloud-based computing solutions, any or all of which may execute any combination of the software components described herein. The server 600 may in some examples, correspond to any of the computing systems or devices described above, such as a CI/CD system 102, a validation system 104, various validation tools and/or APIs 114, user devices 108, and/or any other computing devices, systems, or components executing the software components described herein. It will be appreciated that in various examples described herein, a server 600 might not include all of the components shown in FIG. 6, may include additional components that are not explicitly shown in FIG. 6, and/or may utilize a different architecture from that shown in FIG. 6.

The server 600 includes a baseboard 602, or “motherboard,” which may be a printed circuit board to which a multitude of components or devices are connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the server 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the server 600. The chipset 606 can further provide an interface to a computer-readable storage medium such as a ROM 610 or non-volatile RAM (“NVRAM”) for storing basic routines that help to startup the server 600 and to transfer information between the various components and devices. The ROM 610 or NVRAM can also store other software components necessary for the operation of the server 600 in accordance with the configurations described herein.

The server 600 can operate in a networked environment using logical connections to remote computing devices and computer systems through a network, such as the network 618, which may be similar or identical to any of the communication networks discussed above. The chipset 606 also may include functionality for providing network connectivity through a Network Interface Controller (NIC) 612, such as a gigabit Ethernet adapter. The NIC 612 is capable of connecting the server 600 to other computing devices (e.g., operator devices, external software development environments, test systems, cloud-based deployment systems, etc.) over the network 618. It should be appreciated that multiple NICs 612 can be present in the server 600, connecting the computer to other types of networks and remote computer systems. In some instances, the NICs 612 may include at least on ingress port and/or at least one egress port.

The server 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device.

The server 600 can include one or more storage device(s) 620, which may be connected to and/or integrated within the server 600, that provide non-volatile storage for the server 600. The storage device(s) 620 can store an operating system 622, data storage systems 624, and/or applications 626, which may include any or all of the systems and/or components described herein. The storage device(s) 620 can be connected to the server 600 through a storage controller 614 connected to the chipset 606. The storage device(s) 620 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The server 600 can store data on the storage device(s) 620 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device(s) 620 are characterized as primary or secondary storage, and the like.

For example, the server 600 can store information to the storage device(s) 620 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The server 600 can further read information from the storage device(s) 620 by detecting the physical states or characteristics of one or more particular locations within the physical storage units.

In addition to the storage device(s) 620 described above, the server 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the server 600. In some examples, the various operations performed by the computing systems described herein (e.g., CI/CD system 102, validation system 104, validation tools and/or APIs 114, etc.) may be implemented within a datacenter including one or more servers or devices similar to server 600. For instance, some or all of the operations described herein may be performed by one or more server 600 operating in a networked (e.g., client-server or cloud-based) arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device(s) 620 can store an operating system 622 utilized to control the operation of the server 600. In some examples, the operating system 622 comprises a LINUX operating system. In other examples, the operating system 622 comprises a WINDOWS® SERVER operating system from MICROSOFT Corporation of Redmond, Washington. In further examples, the operating system 622 can comprise a UNIX operating system or one of its variants. It should be appreciated that other operating systems can also be utilized. The storage device(s) 620 can store other system or application programs and data utilized by the server 600.

In various examples, the storage device(s) 620 or other computer-readable storage media is encoded with computer-executable instructions which, when loaded into the server 600, transform the computer from a general-purpose computing system into a special-purpose computer capable of implementing various techniques described herein. These computer-executable instructions transform the server 600 by specifying how the CPUs 604 transition between states, as described above. In some examples, the server 600 may have access to computer-readable storage media storing computer-executable instructions which, when executed by the server 600, perform the various techniques described herein. The server 600 can also include computer-readable storage media having instructions stored thereupon for performing any of the other computer-implemented operations described herein.

As illustrated in FIG. 6, the storage device(s) 620 may store one or more data storage systems 624 configured to store data structures and other data objects. In some examples, data storage systems 624 may include one or more data stores, which may be similar or identical to the metadata repository 110, the validations data store 112 described above, and/or additional data stores storing requests for software deployments (e.g., change events), validation results and/or metrics, etc. Additionally, the software applications 626 stored on the server 600 may include one or more client applications, services, and/or other software components. For example, application(s) 626 may include any combination of the components discussed above in relation to the validation system 104, including client-side components that may be configured to execute on user devices 108, and/or any other software components described above in reference to FIGS. 1-5.

As illustrated by these examples, the techniques described herein provide a number of technical advantages in the fields of the software development and deployment environments tools, as well as for CI/CD systems. For example, the techniques herein improve the security and efficiency of integrating and/or deploying software in various deployment environments. By automatically determining and executing set of validations for change events (or other software deployment requests) based on the metadata attributes of the changed software, the deployment environment, and the user (e.g., developer) requesting the change, the validation systems described herein provide a robust and flexible system that ensures that a customized set include all appropriate validations can be performed for each software deployment request.

Further, the customized set of validations may be determined and executed automatically, including receiving and aggregating the results, in response to the submission of the change event by the developer. As a result, the execution of the required validations and receiving approval from the deployment user can be performed more quickly with fewer delays, leading to more efficient code integration and deployment cycles.

Finally, the techniques described herein provide additional advantages of centralized storage, management, and analytics of validation metrics that are applicable for large organizations and/or large-scale applications. As discussed above, the validation system 104 may store and track the sets of validations performed for large numbers of code integrations/deployments. These metrics can be aggregated, analyzed, and reported in terms of software components, developers or development teams, deployment environments, and/or validations or validation groups, thereby allowing organizations to determine and monitor validation requirements more effectively.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

As used herein, the term “based on” can be used synonymously with “based, at least in part, on” and “based at least partly on.”

As used herein, the terms “comprises/comprising/comprised” and “includes/including/included,” and their equivalents, can be used interchangeably. An apparatus, system, or method that “comprises A, B, and C” includes A, B, and C, but also can include other components (e.g., D) as well. That is, the apparatus, system, or method is not limited to components A, B, and C.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A computer-implemented method, comprising:
receiving, by a validation system, a software deployment request, the software deployment request including an identifier associated with a software component and a deployment location;
retrieving, by the validation system, metadata associated with the software component, based on the identifier;
determining, by the validation system, a set of validations associated with the software deployment request, based at least in part on the metadata and the deployment location;
initiating one or more validation processes, based at least in part on the set of validations;
determining, by the validation system, a set of results of the one or more validation processes; and
initiating, by the validation system, deployment of the software component to the deployment location, based at least in part on the set of results.

2. The computer-implemented method of claim 1, further comprising:
rendering, via a user interface, the set of results of the one or more validation processes; and
receiving a user response via the user interface,
wherein initiating the deployment of the software component is based at least in part on the user response.

3. The computer-implemented method of claim 1, further comprising:
determining a user associated with the software deployment request; and
recording, in a validation results data store, an association between the set of results and the user.

4. The computer-implemented method of claim 1, wherein determining the set of validations comprises:
determining a first deployment platform associated with the deployment location; and
determining a first validation based on the first deployment platform.

5. The computer-implemented method of claim 1, wherein determining the set of validations comprises at least one of:
determining a criticality level associated with the software component; or
determining whether the software component is a consumer-facing application.

6. The computer-implemented method of claim 1, wherein initiating the one or more validation processes comprises:
initiating, prior to deploying the software component to the deployment location, a first validation process on the software component; and
initiating, prior to deploying the software component to the deployment location, a second validation process on a computing environment associated with the deployment location.

7. The computer-implemented method of claim 1, wherein initiating the one or more validation processes comprises:
executing a first validation process configured to verify the presence of documentation associated with the software deployment request, at a network location separate from the deployment location.

8. The computer-implemented method of claim 1, further comprising:
receiving a second software deployment request including the identifier associated with a software component, wherein the software deployment request is associated with a first time and the second software deployment request is associated with a second time after the first time;
retrieving second metadata associated with the software component, based on the identifier, wherein the second metadata is different from the metadata;
determining a set of second validations associated with the second software deployment request, based at least in part on the second metadata, wherein the second set of validations is different from the set of validations;
initiating one or more additional validation processes, based at least in part on the second set of validations;
determining a second set of results of the one or more validation processes; and
initiating second deployment of the software component to the deployment location, based at least in part on the second set of results.

9. The computer-implemented method of claim 1, further comprising:
receiving a second software deployment request including the identifier associated with a software component and a second deployment location different from the deployment location;
determining a set of second validations associated with the second software deployment request, based at least in part on the metadata and the second deployment location, wherein the second set of validations is different from the set of validations;
initiating one or more additional validation processes, based at least in part on the second set of validations;
determining a second set of results of the one or more validation processes; and
initiating second deployment of the software component to the second deployment location, based at least in part on the second set of results.

10. A computer system, comprising:
one or more processors; and
one or more non-transitory computer-readable media storing computer-executable instructions that, when executed by the one or more processors, cause the one or more processors to perform operations comprising:
receiving a software deployment request, the software deployment request including an identifier associated with a software component;
determining a user associated with the software deployment request;
retrieving metadata associated with the software component, based on the identifier;
determining a set of validations associated with the software deployment request, based at least in part on the metadata associated with the software component;
initiating one or more validation processes, based at least in part on the set of validations;
determining a set of validation results of the one or more validation processes; and
recording, in a validation results data store, an association between the set of validation results and the user.

11. The computer system of claim 10, wherein determining the set of validations is based at least in part on the user associated with the software deployment request.

12. The computer system of claim 10, wherein determining the set of validations comprises:
determining a development group associated with the software deployment request; and
determining a first validation associated with the development group.

13. The computer system claim 10, wherein determining the set of validations comprises:
determining a first cloud deployment platform associated with the software deployment request; and
determining a first validation based on the first cloud deployment platform.

14. The computer system of claim 10, the operations further comprising:
rendering, via a user interface, the set of results of the one or more validation processes; and
receiving a user response via the user interface.

15. The computer system of claim 14, the operations further comprising:
initiating deployment of the software component to a deployment location, based at least in part on the set of results and the user response.

16. One or more non-transitory computer-readable media storing instructions executable by a processor, wherein the instructions, when executed by the processor, cause the processor to perform operations comprising:
receiving a software deployment request including a software component identifier associated with a software component and a deployment location;
retrieving metadata associated with the software component, based on the software component identifier;
determining a set of validations associated with the software deployment request, based at least in part on the metadata;
initiating one or more validation processes, based at least in part on the set of validations;
determining a set of results of the one or more validation processes; and
initiating deployment of the software component to the deployment location, based at least in part on the set of results.

17. The non-transitory computer-readable media of claim 16, the operations further comprising:
rendering, via a user interface, the set of results of the one or more validation processes; and
receiving a user response via the user interface,
wherein initiating the deployment of the software component is based at least in part on the user response.

18. The non-transitory computer-readable media of claim 16, the operations further comprising:
determining a user associated with the software deployment request; and
recording, in a validation results data store, an association between the set of results and the user.

19. The non-transitory computer-readable media of claim 16, wherein determining the set of validations comprises:
determining a first deployment platform associated with the deployment location; and
determining a first validation based on the first deployment platform.

20. The non-transitory computer-readable media of claim 16, wherein determining the set of validations comprises at least one of:
determining a criticality level associated with the software component; or
determining whether the software component is a consumer-facing application.
